(19) United States
(12) Patent Application Publication
(10) Pub. No.: US 2010/0052881 A1
(43) Pub. Date: Mar. 4, 2010

(54) EMERGENCY STARTING SYSTEM OF VEHICLE AND METHOD THEREOF

(75) Inventors: Jeong Ki Lee, Jeollanam-do (KR); Eun Beom Choi, Seoul (KR); Joon Ho Choi, Seoul (KR); Sin Gu Kim, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/481,762

(22) Filed: Jun. 10, 2009

(30) Foreign Application Priority Data
Aug. 29, 2008 (KR) 10-2008-0085060

(51) Int. Cl. B60Q 1/00; G05B 19/00; G08B 29/00; G08B 21/00; G08B 23/00

(52) U.S. Cl. 340/425.5; 340/5.61; 340/5.8; 340/540; 340/693.2

(57) ABSTRACT

The present invention relates to a button starting system for a vehicle which is able to stably start up by using an LF antenna installed in the vehicle in an emergency of a smart key. According to the system, the necessity of installation of a key holder can be removed.

### CROSS-REFERENCE TO RELATED APPLICATION

This application claims under 35 U.S.C. §119(a) the benefit of Korean Patent Application No. 10-2008-85060 filed on Aug. 29, 2008, the entire contents of which are incorporated herein by reference.

### BACKGROUND OF THE INVENTION

The present invention relates to an emergency starting system and method of vehicle, more particularly, to a technology which is capable of normally operating a smart key including a key FOB in an emergency, by using an LF (Low Frequency) antenna provided in the vehicle.

Immobilizer systems are used to prevent vehicle theft through the communication between a start key and the vehicle.

According to a typical immobilizer system for a vehicle, an encryption code is generated from a key FOB or a smart key, the encryption code is transmitted to the smart key controller installed in the vehicle for authentication, and if it is authenticated, the vehicle is started. The authentication is performed by comparing the received encryption code with an ID which has been stored in advance.

In the immobilizer system, the key FOB or the smart includes a built-in transponder storing a security program related to the prevention of vehicle theft and an ID code. The transponder performs the function of generating the encryption code.

Referring to FIG. 1, the operation of a conventional button starting system will be illustrated.

If a driver presses a button to start a vehicle, the input of the start button is sensed through a button input unit 2. When the input of the start button is sensed, a smart key controller 6 controls an LF antenna to output an LF wakeup signal. The LF wakeup signal is received in the transponder of a smart key 4. The transponder transmits to an RF response signal including the ID of the smart key in response to the LF wakeup signal. An RF receiver 10 transmits the ID of the smart key which is loaded in the received RF response signal to the smart key controller 6. If the ID coincides with the ID code which has been registered in advance in the smart key 4, the smart key controller 6 transmits a starting permission message to an engine starting controller 12. The engine starting controller 12 operates an engine (not shown) if the starting permission message is received.

In the meantime, if the battery which is built in a smart key 4 is exhausted, the smart key 4 is unable to generate the RF response signal according to the LF wakeup signal which is transmitted from an LF antenna 8. In the present invention, as described above, the state where the smart key 4 is unable to generate the RF response signal according to the LF wakeup signal due to the battery exhaustion is defined as “emergency” state.

In an emergency state, after controlling the LF antenna 8 to transmit the LF wakeup signal, the smart key controller 6 waits for the ID reception of the smart key through the RF receiver 10. However, if the RF response signal is not transmitted from the smart key 4 for a predetermined time, the smart key controller 6 transits to an emergency starting state.

After the transition to the emergency starting state, if the smart key 4 is inserted into a key holder 14 which is provided in the vehicle separately, the smart key 4 is charged with a magnetic force generated from the key holder 14 and outputs a signal including an encrypted transponder code. After the key holder 14 extracts the encrypted transponder code from the received signal, the validity of the ID included in the extracted transponder code is determined so that the result is transmitted to the smart key controller 6. If the ID is determined to be valid, the smart key controller 6 transmits the starting permission message to the engine starting controller 12 so that the engine is started. Typically, the key holder 14 is installed in the vehicle around the start button 1.

The installation position has to be considered in the vehicle interior design and the installation is an element to increase overall vehicle manufacturing costs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides an emergency starting system capable of stably starting a vehicle by using an LF antenna installed inside the vehicle, which obviates the necessity of setting up a key holder in the vehicle.

In one aspect, the present invention provides an emergency starting system of a vehicle including a button starting system. The system may include a smart key controller an emergency alarm unit. The smart key controller, when the smart key is working properly, controls the operation of engine of the vehicle to start in conjunction with a smart key when the button is pressed. On the other hand, when the smart key is in an emergency state, the smart key controller operates the smart key by transmitting an LF wakeup signal having an improved transmission power through an LF antenna installed inside the vehicle, authenticates the smart key through an LF response signal received from the smart key and controls the operation of the engine according to the authentication result.

The emergency alarm unit functions to notify, under the control of the smart key controller, the emergency state of the smart key.

In another aspect, the present invention provides an emergency starting method of a vehicle including a button starting system. The emergency starting method may comprise the steps of: (a) transmitting an LF wakeup signal with improved transmission power through an LF antenna installed inside the vehicle, when an emergency of a smart key is sensed; (b) notifying a driver of the emergency of the smart key; (c) performing authentication of the smart key by using an LF response signal transmitted from the smart key through the LF antenna; and (d) operating an engine in the case of successful authentication of the smart key.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a block diagram of a conventional button starting system.

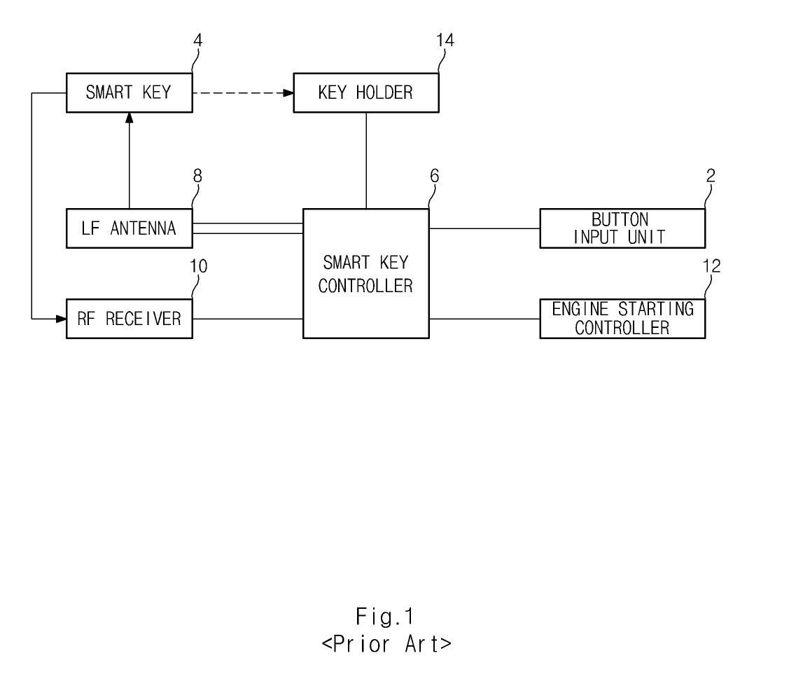

FIG. 2 is a diagram illustrating a smart key holder and a start button of a conventional button starting system.

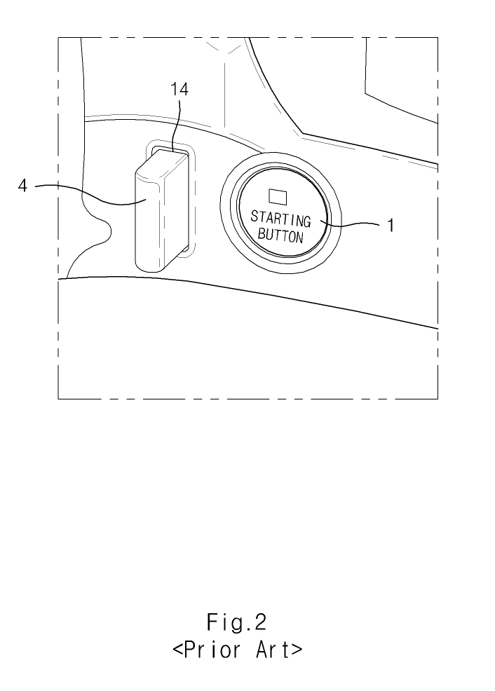

FIG. 3 is a block diagram of an emergency starting system of a vehicle including a button starting system according to an embodiment of the present invention.

FIG. 4 is a detailed configuration diagram of an LF antenna driving unit that is illustrated in FIG. 3.

FIG. 5 is a flowchart that illustrates an emergency starting method of a vehicle including a button starting system according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use in the environment.

### DETAILED DESCRIPTION OF THE EMBODIMENTS

Hereinafter, exemplary embodiments of the present invention will be described in detail with reference to the attached drawings

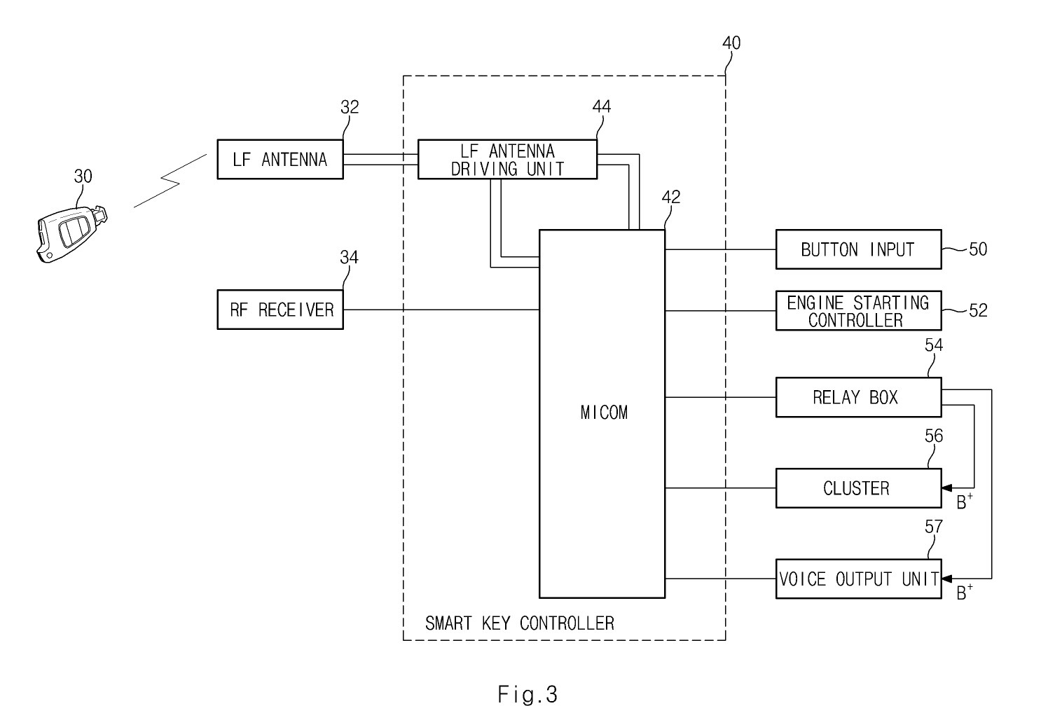

FIG. 3 is a block diagram of an emergency starting system of a vehicle including a button starting system according to an embodiment of the present invention.

The transponder of a smart key 30 is charged from an LF wakeup signal received from an LF antenna 32. When the charged voltage reaches the operating voltage of the transponder, the smart key 30 transmits an LF response signal in which an encrypted transponder code information is loaded.

The LF antenna 32 is installed at the vicinity of a cup holder inside the vehicle. The LF antenna 32 functions to transmit the LF wakeup signal to the transponder under the control of a smart key controller 40 and extract the encrypted transponder code information from the LF response signal to transmit to the smart key controller 40.

An RF receiver 34 receives an RF response signal transmitted from the smart key 30 which changes to a steady-state, extracts an encrypted ID information from the received RF response signal and transmits the extracted the encrypted ID information to the smart key controller 40.

The smart key controller 40 controls the LF antenna 32 in an emergency so that the LF wakeup signal is transmitted to the smart key 30, and performs the transponder authentication on the smart key 30 based on the encrypted transponder code information which is transmitted from the LF antenna 32. In the case when the transponder is successfully authenticated, a starting permission message is transmitted to an engine starting controller 52.

As shown in FIG. 3, the smart key controller 40 may comprise an LF antenna driving unit 44 and a MICOM 42.

The MICOM 42 performs an overall control in the smart key controller 40. In particular, it controls the LF antenna driving unit 44 so that the LF wakeup signal is transmitted through the LF antenna 32 or the LF antenna 32 goes into a reception waiting state.

A button input unit 50 transmits a button input signal to the smart key controller 40 when the start button is pressed down by a user.

The engine starting controller 52 starts an engine (not shown) when a starting permission message is transmitted from the smart key controller 40.

A relay box 54 forms a relay to supply electric power to the whole vehicle, supplying the operating voltage to a cluster 56 under the control of the smart key controller 40. In the state where the cluster 56 is operating by the voltage supplied from the relay box 54, it notifies an emergency starting state or an emergency starting failure state to the driver under the control of the smart key controller 40. According to a specification of the cluster 56, the emergency starting state or the emergency starting failure state can be outputted with a character type or a ramp type.

A voice output unit 57 outputs a voice message according to the place where the smart key 30 should be placed under the control of the smart key controller 40, for example, “It is an emergency starting mode. Please move the smart key to the vicinity of cup holder”.

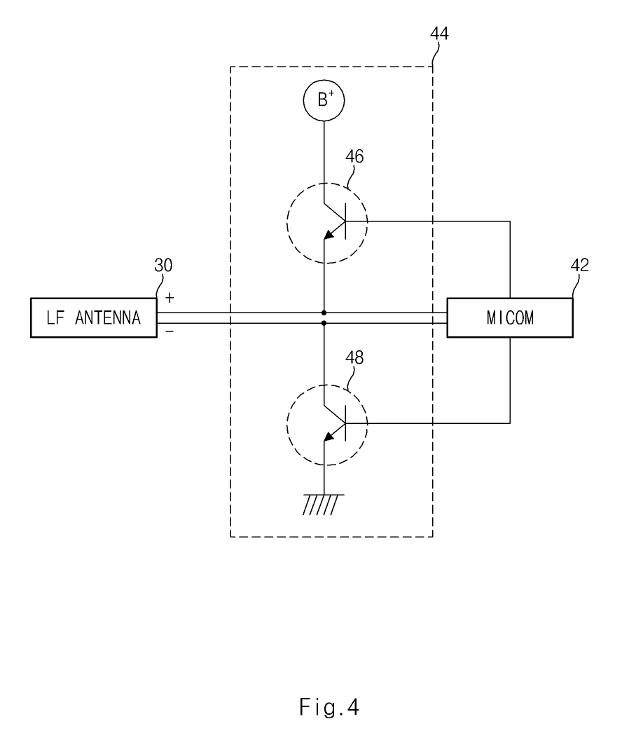

The detail configuration of the LF antenna driving unit 44 illustrated in FIG. 3 is shown in FIG. 4.

As shown in FIG. 4, the LF antenna driving unit 44 includes power control means 46, 48 each of which controls the supply of electric power to the LF antenna 30 under the control of the MICOM 42.

More particularly, the LF antenna driving unit 44 includes a first power control means 46 to vary the voltage supplied to a first connection line between the LF antenna 30 and the MICOM 42 or to block the supply of the voltage, and a second power control means 48 to bypass a second connection line between the LF antenna 30 and the MICOM 42 to ground. In the present invention, the first power control means 46 and the second power control means 48 may comprise a transistor TR. By controlling the current applied to the base of the transistor TR corresponding to the first power control means 46, the MICOM 42 can control the voltage applied to the LF antenna 30 through the first connection line.

Using such configuration features, the MICOM 42 can control the energy transmission power of the LF antenna 30. The transponder charging time of the smart key 30 can be controlled according to the energy transmission power. The first connection line is connected to the + end of the LF antenna 30, whereas the second connection line is connected to − end of the LF antenna 30.

As described, if the smart key operates normally, the MICOM 42 provides a reference voltage corresponding to the voltage which is generally provided for the immobilizer communications to the LF antenna 30. On the other hand, if the smart key is in an emergency state, the MICOM 42 controls the first power control means 46 so that a voltage higher than the reference voltage may be applied to the LF antenna 30.

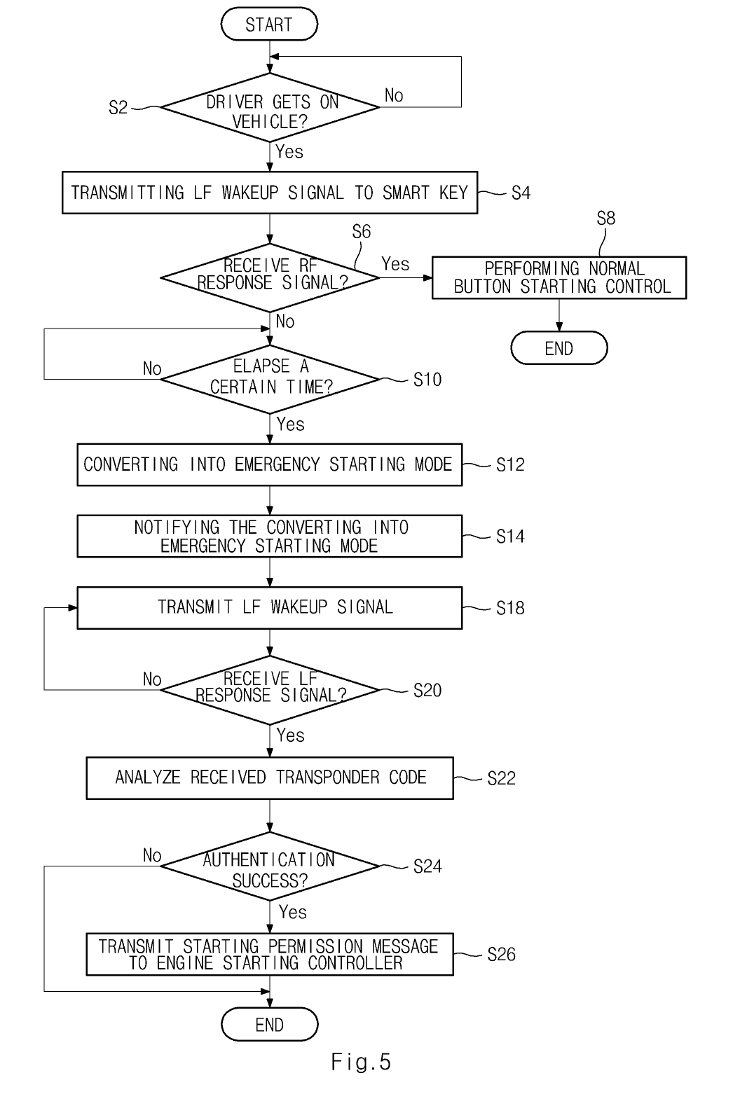

The operation of an emergency starting system of a vehicle including a button starting system according to an embodiment of the present invention will be illustrated with reference to a flowchart illustrated in FIG. 5.

At step S2, the smart key controller 40 determines whether a driver gets in a vehicle, and controls the LF antenna driving unit 44 so that a voltage is supplied to the LF antenna 30 when it is determined that the driver gets in the vehicle. In this process, the MICOM 42 of the smart key controller 40 controls the LF antenna driving unit 44 so that the first and the second power control means 46, 48 are turned on and the voltage is supplied to the LF antenna 30. The determination of whether a driver gets in a vehicle can be made by, e.g., a sensing signal according to the opening and closing of a door.

At step S4, the LF antenna 32 transmits the LF wakeup signal to the smart key 30.

At this time, if the smart key 30 is operating normally, the smart key 30 generates the RF response signal and transmits it so as to respond to the LF wakeup signal. If the smart key 30 is not operating normally (i.e., in an emergency state), the smart key 30 is unable to respond to the LF wakeup signal.

At step S6, the smart key controller 40 determines whether the RF response signal is received. If it is determined that the RF response signal is received (YES at S6), a normal button starting control is performed (S8). The term “normal button starting control” is used herein to mean that an engine is controlled to start through an engine starting controller if authentication of a smart key is successful. Since the related technology is well known to a person skilled in the art, the detailed description thereof is omitted.

On the other hand, if it is determined that the RF signal is not received, the smart key controller 40 operates a timer to determine whether a certain time has elapsed in a state in which the RF response signal is not received (S10).

If it is determined that the RF response signal is not received for a certain time, the smart key controller 40 changes to an emergency starting mode (S12), notifying the driver that an emergency starting mode is turned on (S14).

At step S14, the smart key controller 40 controls the relay box 54 to supply the operating voltage to the cluster 56 and/or the voice output unit 57, and commands the cluster 56 and/or the voice output unit 57 to output an emergency starting alarm message, so that the emergency starting alarm message is delivered visually, aurally, or both. As described above, the voice message, for example, “It is an emergency starting mode. Please move the smart key to the vicinity of cup holder” can be outputted through the voice output unit 57. Through such notification, the driver can move the smart key 30 to a specific location guided by the cluster 56 (for example, the vicinity of cup holder or cluster) or other places.

In the case the emergency starting alarm message is ordered to be outputted, for instance, the cluster 56 can output a corresponding emergency starting alarm message with a character style, or with a lamp style according to the performance.

The smart key controller 40 may supply power to the LF antenna 32 until the LF response signal is received from the smart key 30, so that the LF wakeup signal for the power transmission is transmitted through the LF antenna 32. The smart key controller 40 may block the power supply of the LF antenna 32 so that the LF antenna 32 changes to a reception waiting state (S18).

While the LF wakeup signal, a magnetic force control, is transmitted from the LF antenna 32, the transponder of the smart key 30 is charged until it reaches its operating voltage. When the charging of the operating voltage is completed, the transponder of the smart key 30 generates the LF response signal in which the encrypted transponder TP code information is included and transmits the LF response signal.

At step S18, the MICOM 42 controls the current amount applied to the base of the first power control means 46 to increase the voltage applied to the LF antenna 30 through the first connection line, while turning the base of the second power control means 48 on to bypass the voltage of the second connection line to ground.

At step S20, the smart key controller 40 determines whether the LF response signal is received through the LF antenna 32. Step S18 is performed repeatedly until the LF response signal is received. That is, step S18 is periodically performed when the transponder of the smart key 30 is charged. Therefore, the LF wakeup signal is periodically transmitted from the LF antenna 32.

If it is determined that the LF response signal is received (S20), the smart key controller 40 analyzes the encrypted transponder code information which is included in the received LF response signal and determines whether it is identical to the transponder code information which has been stored in advance (S22).

If it is determined that the transponder code information transmitted from the smart key 30 is identical to the transponder code information stored in advance, it is determined as a successful authentication (S24) so that the starting permission message is transmitted to the engine starting controller 52 and operations are terminated (S26).

On the other hand, if it is determined that they are not identical, it is determined as an authentication failure (S24) and operations are terminated. In another embodiment of the present invention, if the authentication fails, an authentication failure message can be indicated on the cluster 56 so that the driver is notified.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An emergency starting system of a vehicle including a button starting system, the emergency starting system comprising:
a smart key controller which normally controls the operation of engine of the vehicle to start in conjunction with a smart key when the button is pressed, while when the smart key is in an emergency state, operating the smart key by transmitting an LF wakeup signal of which the transmission power is improved through an LF antenna installed inside the vehicle, authenticating the smart key through an LF response signal received from the smart key, and controlling the operation of the engine according to the authentication result; and
an emergency alarm unit which notifies, under the control of the smart key controller, the emergency state of the smart key.

2. The emergency starting system of claim 1, wherein the smart key controller periodically transmits the LF wakeup signal until the LF response signal is received.

3. The emergency starting system of claim 1, wherein the emergency alarm unit comprises a cluster which indicates, under the control of the smart key controller, the state of emergency starting alarm visually.

4. The emergency starting system of claim 3, further comprising a relay box which provides power to the cluster in an emergency of the smart key.

5. The emergency starting system of claim 1, wherein the emergency alarm unit comprises a voice output unit which indicates, under the control of the smart key controller, the state of emergency starting alarm aurally.

6. The emergency starting system of claim 5, further comprising a relay box which provides power to the voice output unit in an emergency of the smart key.

7. The emergency starting system of claim 5, wherein the voice output unit outputs a voice message which guides the smart key to be located at a specific position inside the vehicle while the driver is informed of the state of emergency starting.

8. The emergency starting system of claim 1, wherein the smart key controller comprises:
an LF antenna driving unit that supplies to the LF antenna a power for the transmission of an LF wakeup signal; and
a MICOM that controls the LF antenna driving unit in an emergency of the smart key to increase the transmission power of the LF wakeup signal.

9. The emergency starting system of claim 8, wherein the MICOM controls the LF antenna driving unit in such a manner that a reference voltage is supplied to the LF antenna if the smart key operates normally, whereas a voltage higher than the reference voltage is supplied to the LF antenna if the smart key is in an emergency.

10. The emergency starting system of claim 8, wherein the antenna driving unit comprises:
a first power control means that provides a voltage determined by an amount of current inputted from the MICOM to a + end of the LF antenna; and
a second power control means that bypasses a − end of the LF antenna under the control of the MICOM.

11. The emergency starting system of claim 1, wherein the smart key controller authenticates the smart key by using transponder code information on the smart key included in the LF response signal.

12. An emergency starting method of a vehicle including a button starting system, the emergency starting method comprising the steps of:
(a) transmitting an LF wakeup signal with improved transmission power through an LF antenna installed inside the vehicle, when an emergency of a smart key is sensed;
(b) notifying a driver of the emergency of the smart key;
(c) performing authentication of the smart key by using an LF response signal transmitted from the smart key through the LF antenna; and
(d) operating an engine in the case of successful authentication of the smart key.

13. The emergency starting method of claim 12, wherein the step (b) displays the state of emergency on a cluster of the vehicle.

14. The emergency starting method of claim 12, wherein the step (b) outputs a voice message indicating the state of emergency by using a voice output unit of the vehicle.

15. The emergency starting method of claim 14, wherein the voice message includes a message which requests the smart key to be located at a specific position.

16. The emergency starting method of claim 12, wherein the step (c) authenticates the smart key by using transponder code information on the smart key included in the LF response signal.

17. The emergency starting method of claim 12, wherein the step (a) further comprises determining that the smart key is in an emergency state if an RF response signal is not received within a certain time after transmitting the LF wakeup signal to the smart key, after a driver gets in a vehicle.

18. The emergency starting method of claim 12, wherein the step (a) comprises:
(a1) supplying power to the LF antenna for a certain time for improving transmission power and waiting to receive the LF response signal from the smart key; and
(a2) periodically supplying the power to the LF antenna until the LF response signal is received.
